(19) United States
(12) Patent Application Publication
(10) Pub. No.: US 2001/0038370 A1
(43) Pub. Date: Nov. 8, 2001

(54) Driving scheme for liquid crystal displays

(76) Inventor: Steve Wai Leung Yeung, Tseung kwan O (HK)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/821,387

(22) Filed: Jul. 3, 2001

(30) Foreign Application Priority Data
Mar. 28, 2000 (GB) 0007521.8
May 5, 2000 (GB) 0010979.3

(51) Int. Cl. G09G 3/36

(52) U.S. Cl. 345/87

(57) ABSTRACT

The invention relates to a m-column/n-row/m×n-pixel inversion driving method for a liquid crystal display where m can be any integer from two to the number of scan lines and n can be any integer of two to the number of column lines. Such a driving method greatly reduces total fringe field effect on display to maintain contrast whilst minimizing perception of flickering. Moreover, the number of inversions can be adjusted to strike a balance between contrast and perceptibility of flickering. The n-row inversion method can be applied to passively and actively driven liquid crystal displays where n can be any integer from two to the number of scan lines. The m-column inversion driving method can be applied to an actively driven LCD where m can be any integer from two to the number of column lines while the n×m-pixel inversion method can be applied to an actively driven LCD where n can be any integer from two to the number of scan lines and m can be any integer from two to the number of column lines. This inversion method is particularly useful in actively driven miniature TFT and reflective liquid crystal on silicone displays in contrast to the effect on fringe field if a conventional single row/column/pixel inversion method is used.

The invention relates to passively and actively driven liquid crystal displays and more particularly to the driving of such a display to minimize perception of a flickering effect to an observer.

Liquid crystal displays (LCDs) are well known, but can suffer from flickering, caused by a too fast response to time, so that it responds to a time wave-form and not root-mean-square value (passively driven LCDs) or by a charge imbalance (active driven LCDs).

The reason for the imbalance is that implantation of transistors is carried out on only one of the two surfaces of the substrates. To minimize the perception of flickering in an actively driven LCD, row, column, and pixel inversions have been proposed. The flickering effect is thus spatially averaged out to an extent that is imperceptible. However, this results in reduced contrast due to a fringe field effect occurring on the pixel boundary. The loss is usually negligible when the pixel size is not too small. However, in the case of a miniature display (e.g. amorphous-silicon TFT, poly-silicon TFT, and miniature liquid crystal on silicon), the loss in contrast can be sever and cannot be compensated.

It is an object of the invention to seek to mitigate these disadvantages.

According to the invention, there is provided a method for driving an LCD, comprising the steps of providing an LCD with a number of columns, a number of rows, and a number of pixels, and driving the LCD by multiple inversion of a column, row or pixel, whereby to provide a reduced total fringe field effect to maintain contrast and a minimised flickering on display.

Using the invention it is possible to reduce flickering in a miniature display.

The number of inversions may be adjustable. This provides for flexibility, and provides for striking a balance between contrast and perceptibility of flickering.

Suitably there may be a number of columns (m which may be any integer from two to the number of scan lines and there may be a number of rows (n) which may be any integer from two to the number of column lines. This provides for applicability to different sized LCDs.

There may be an (n)-row inversion applied to a passively and an actively driven LCD, and (n) may be any integer from two to the number of scan lines. This provides for applicability to two forms of driving.

There may be an (m)-column inversion applied to an actively driven LCD, and (m) may be any integer from two to the number of column lines.

There may be an n×m-pixel inversion driving method in an actively driven LCD, where (n) may be any integer from two to the number of scan lines and (m) may be any integer from two to the number of column lines.

The method may be applied to an actively driven miniature TFT LCD and/or reflective liquid crystal on silicon LCD.

Suitably there may be a plurality, preferably a simultaneous inversion of two, columns, two rows or two pixels of an LCD.

A method embodying the invention is hereinafter described, by way of example, with reference to the accompanying drawings.

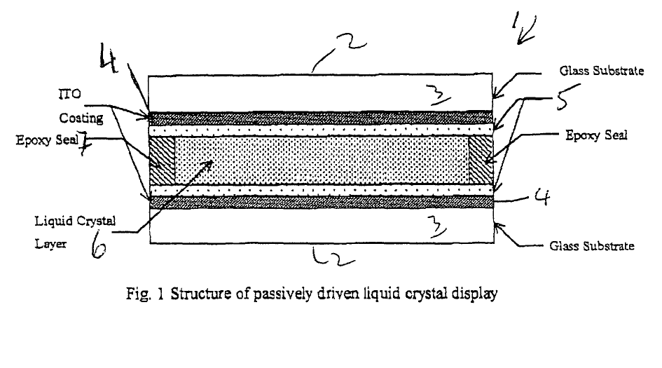

FIG. 1 is a schematic cross-sectional view of the structure of a passively driven LCD;

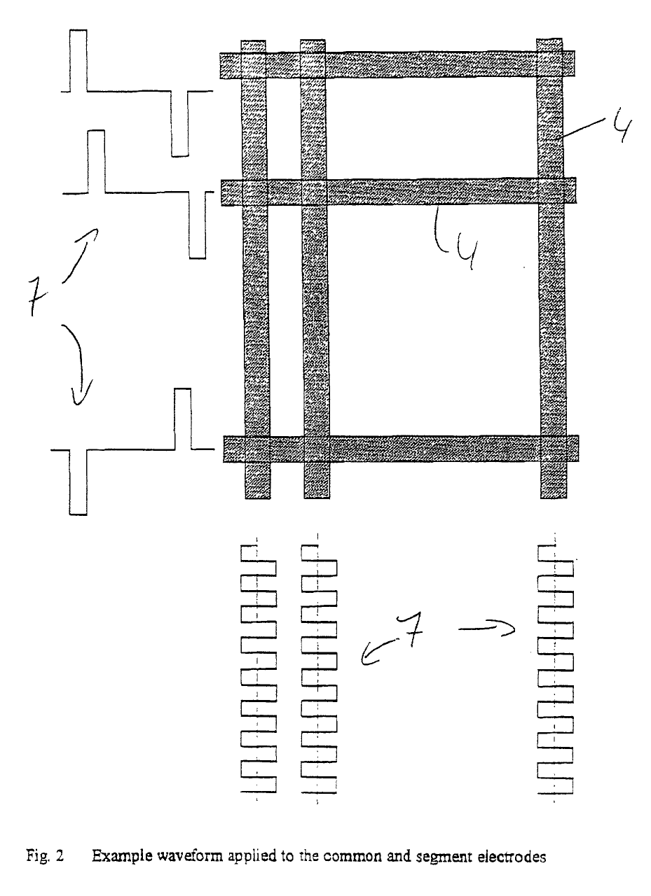

FIG. 2 shows a wave-form applied to common and segment electrodes of an LCD of FIG. 1;

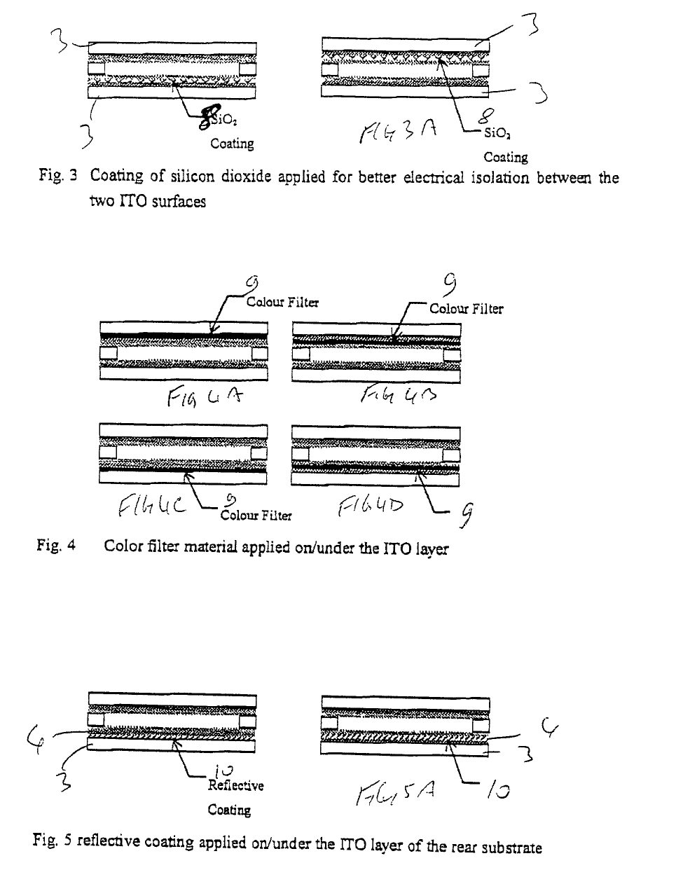

FIG. 3 and FIG. 3A show cross sectional views of a coating of silicon dioxide applied to provide enhanced electrical isolation between two ITO surfaces;

FIGS. 4A-4D show cross sectional views respectively of different positions of a colour filter material applied on or under an ITO layer of an LCD;

FIGS. 5 and 5A show schematically a cross sectional view to an LCD having a reflective coating applied on (FIG. 5) or under an ITO layer of a rear substrate of an LCD;

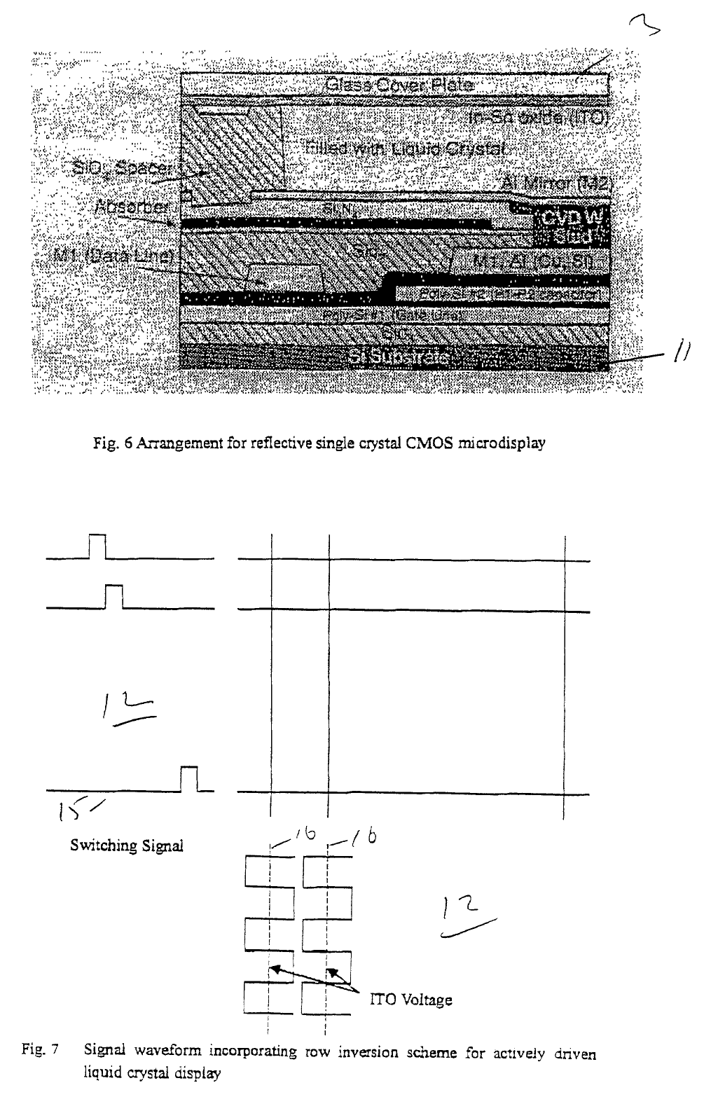

FIG. 6 shows schematically a construction for a reflective signal crystal CMOS micro display;

FIG. 7 shows a signal wave-form incorporating a row inversion method for an actively driven LCD;

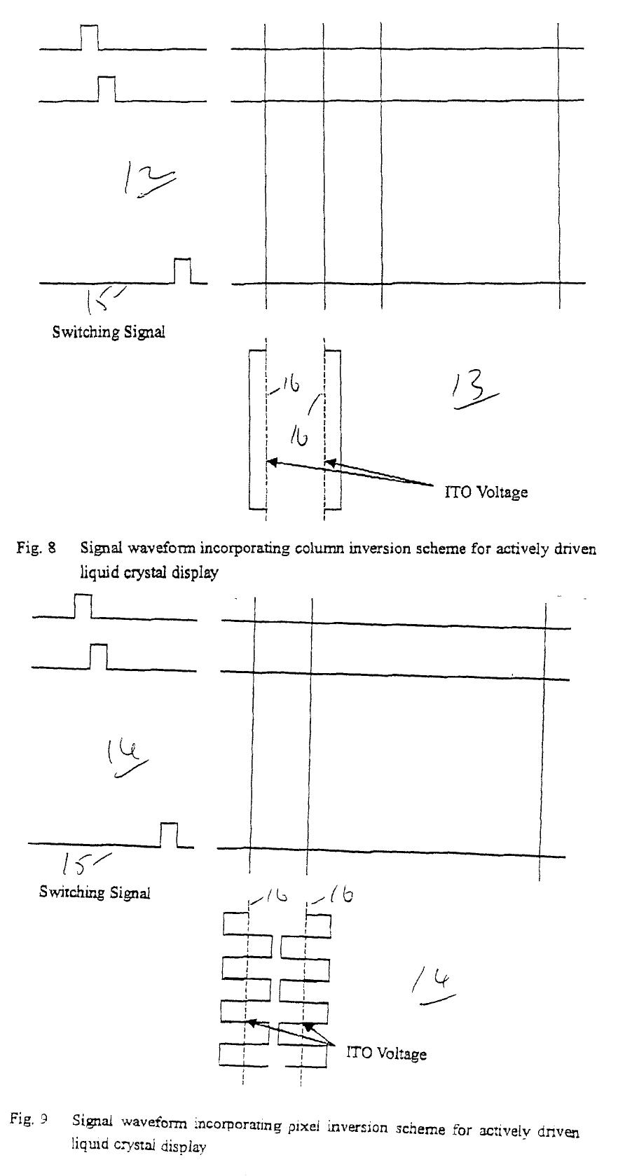

FIG. 8 shows a signal wave-form incorporating a column inversion method for an actively driven LCD;

FIG. 9 shows a signal wave-form incorporating a pixel inversion method for an actively driven LCD;

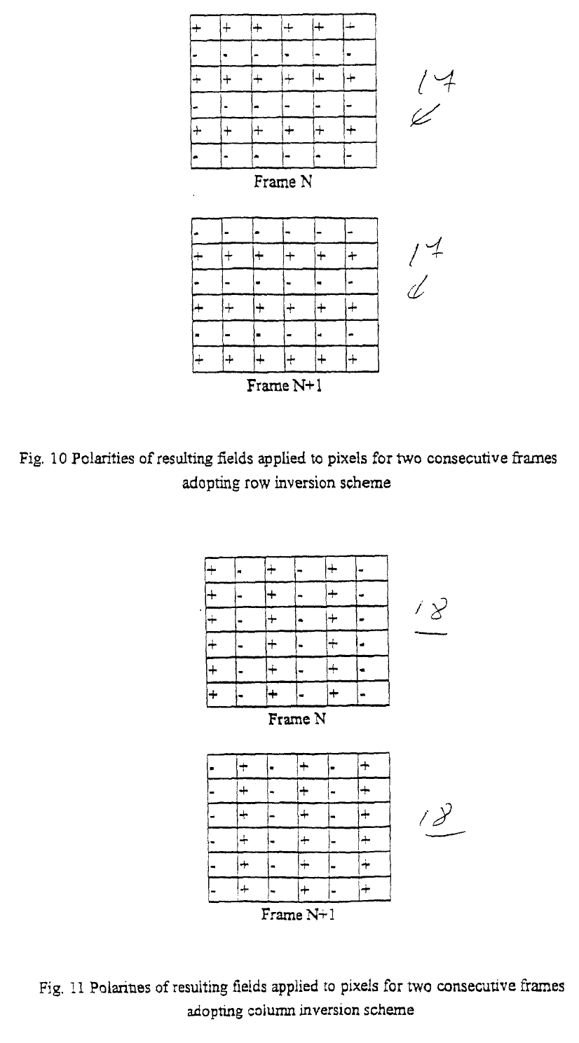

FIG. 10 shows schematically polarities of resulting fields applied to pixels for consecutive frames when using a row inversion method;

FIG. 11 shows schematically polarities of resulting fields applied to pixels for two consecutive frames when adopting a column inversion method;

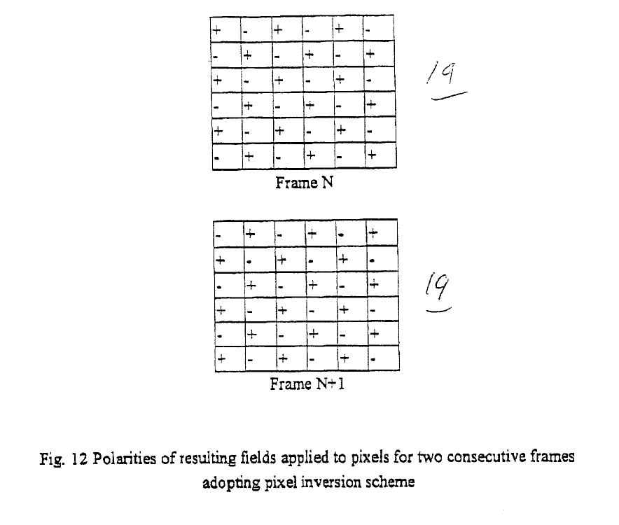

FIG. 12 shows polarities of resulting fields applied to pixels for two consecutive frames when adopting a pixel inversion method;

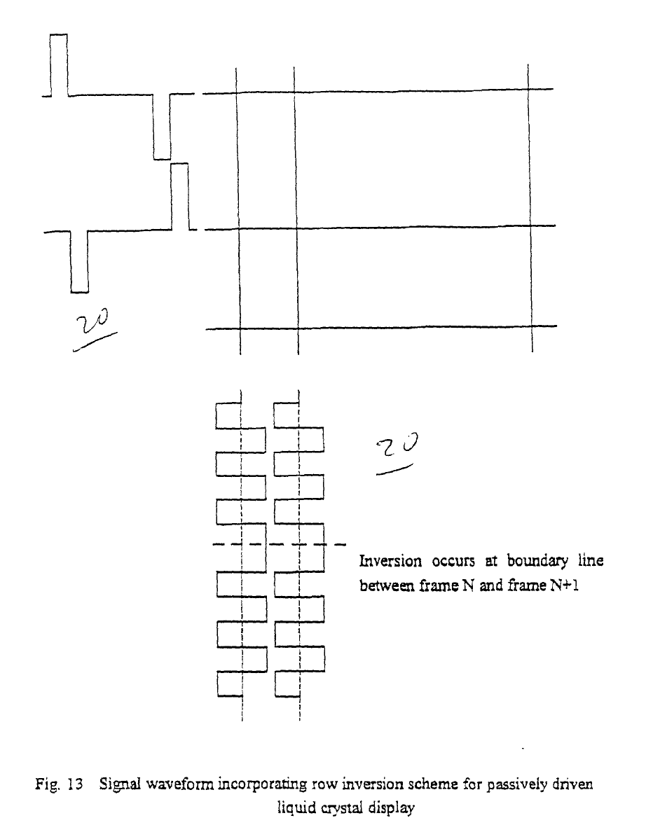

FIG. 13 shows a signal wave-form incorporating a row inversion method for a passively driven LCD;

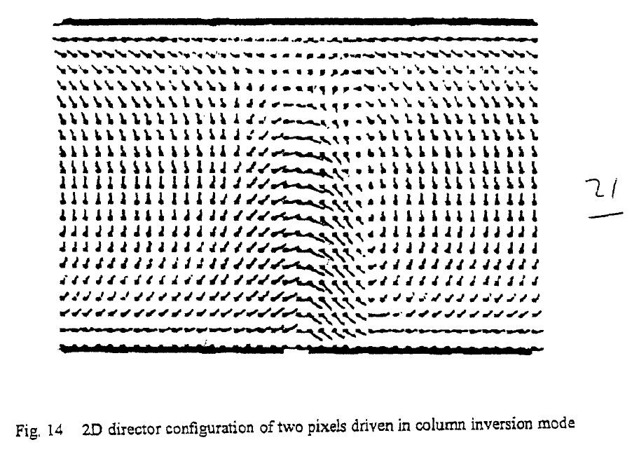

FIG. 14 shows a two-dimensional director configuration for two pixels when driven in a column inversion mode;

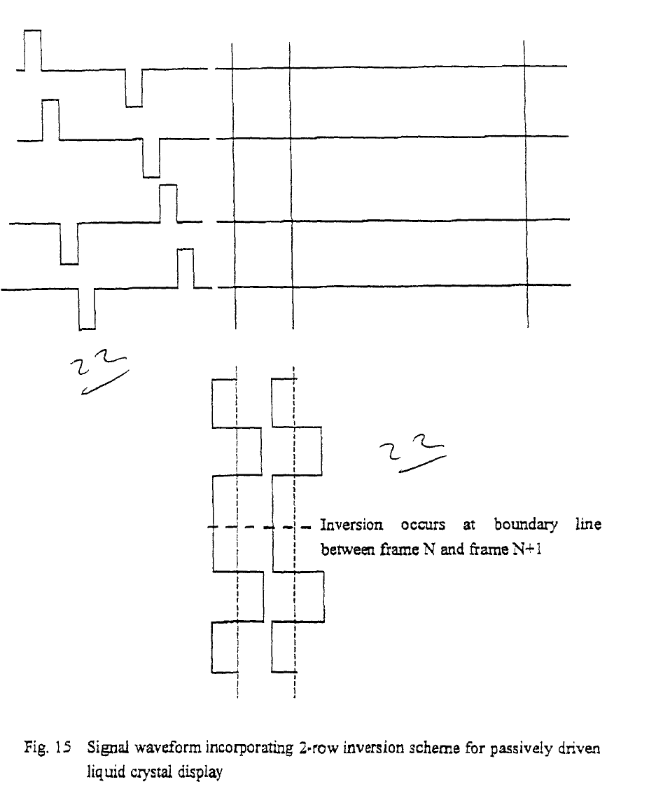

FIG. 15 shows a wave-form incorporating a two-row inversion scheme for a passively driven LCD;

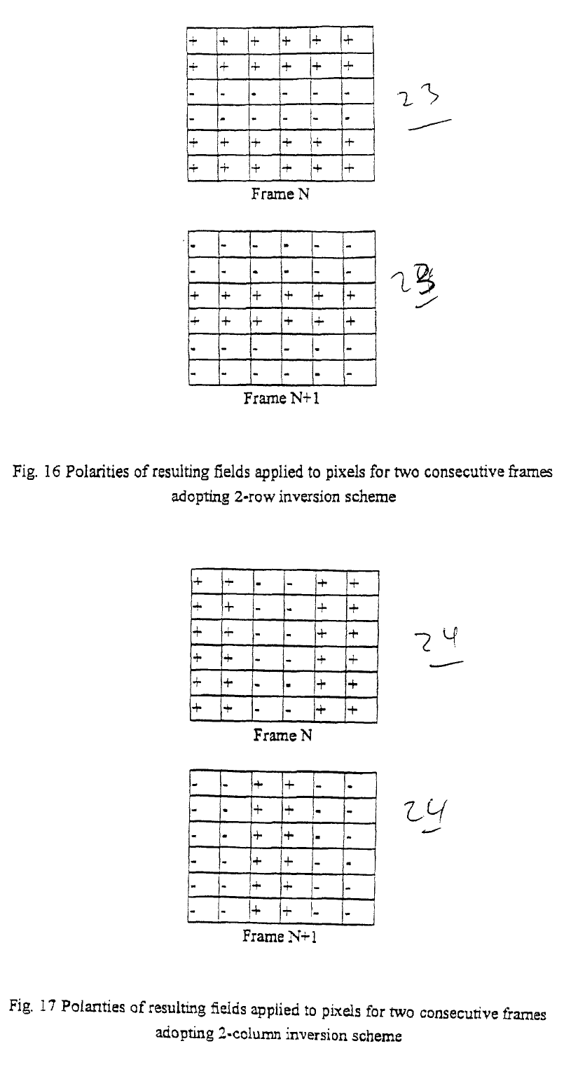

FIG. 16 shows polarities of resulting fields when applied to pixels for two consecutive frames when adopting a two-row inversion method;

FIG. 17 shows polarities of resulting fields when applied to pixels for two consecutive frames when adopting a two-column inversion method;

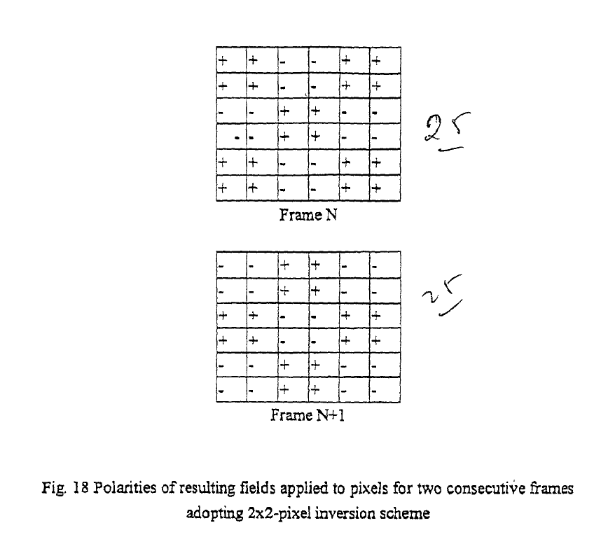

FIG. 18 shows polarities of resulting fields when applied to pixels for two consecutive frames when adopting a n×m=2×2 pixel inversion method;

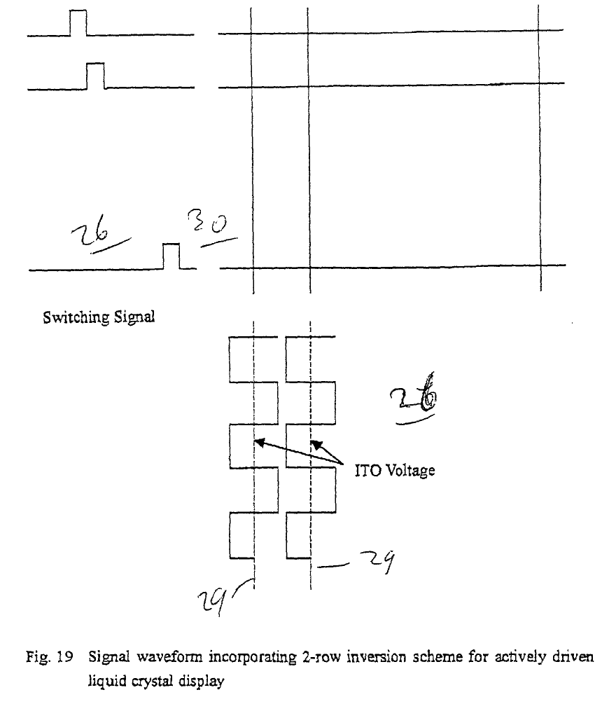

FIG. 19 shows a signal wave-form incorporating a two-row inversion method for an actively driven LCD;

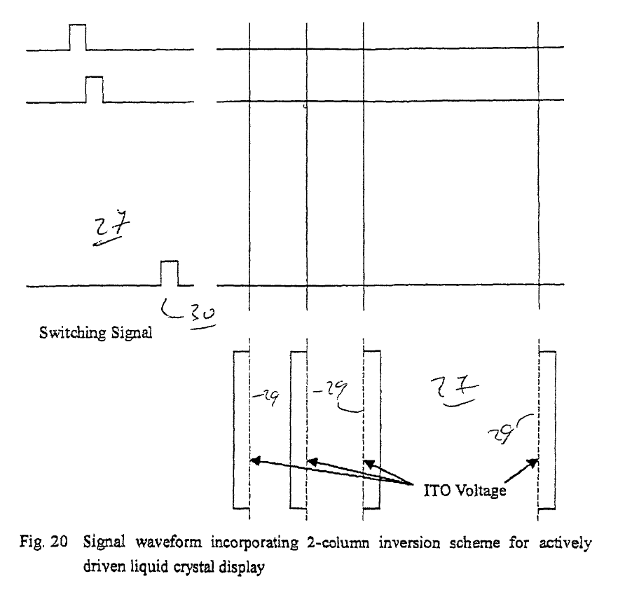

FIG. 20 shows a signal wave-form incorporating a two column inversion method for an actively driven LCD; and

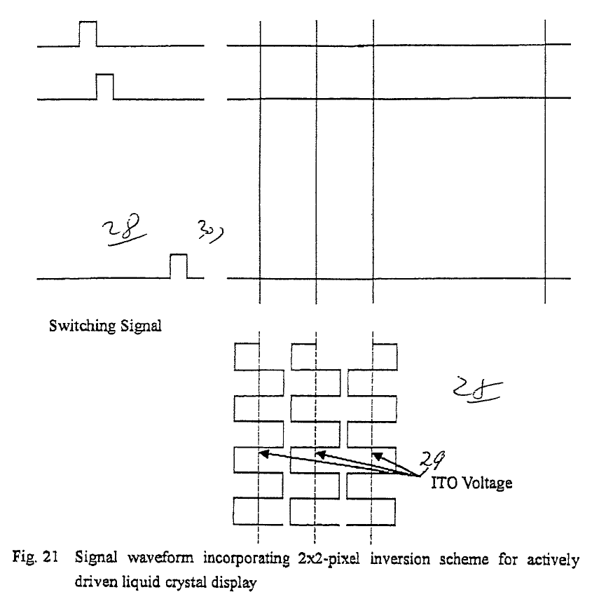

FIG. 21 shows a signal wave-form incorporating a n×m=2×2 pixel inversion method for an actively driven LCD.

Referring to the drawings, there is shown a method for driving an LCD, comprising the steps of providing an LCD with a number of columns (m) and a number of rows (n), the number of pixels being (n×m), and driving the LCD by multiple inversion of a column, row or pixel, whereby to provide a reduced total fringe field effect to maintain contrast and a minimised flickering on display.

FIG. 1 shows a cross sectional view of a structure of a passively driven LCD 1. Polarisers 2 are attached to the outside of glass substrates 3. The inner surface (as viewed) of each glass substrate 3 is coated with a conductive medium preferably an Indium Tin Oxide (ITO) film 4 on which a coating of a polyamide film 5 is applied for alignment of liquid crystal molecules in a liquid crystal layer 6.

An enclosure between the glass substrates 3 is formed by seals usually an epoxy seal 7 such as an epoxy glue, a liquid crystal material being filled in the space so formed. The structure of the LCD is symmetrical with respect to the liquid crystal layer 6. The matrix addressing protocol is then applied to the ITO coatings 4, which form electrodes, for addressing individual pixel formation obtained by the intersection of the ITO lines. Frame inversion is adopted to avoid net DC applied to the LCD 1. Thus FIG. 2 shows an example of a waveform 7 applied to the common and segment ITO electrodes 4. A flickering effect may still be observed owing to the fact that liquid crystal material molecules are usually not perfectly non-polar. In such a case, the flickering effect can be minimised by adopting a high enough frame frequency. In some instances, the arrangement of the LCD is not symmetrical.

FIG. 3 and FIG. 3A show an arrangement such that underneath the polyamide coating a coating 8 of silicon dioxide is applied for providing better electrical isolation between the two ITO surfaces.

FIG. 4A to FIG. 4D show an LCD where a colour filter material is applied, in FIG. 4A the colour filter material being on the rear glass substrate, underneath the front glass substrate or on or under the ITO layer, in each case the colour filter material being indicated by numeral 9.

A further embodiment is shown in FIG. 5 and FIG. 5A where a reflective coating 10 is applied on or under the ITO layer of the rear glass substrate 3. These different additions, FIGS. 3-5A, result in a loss of symmetry of the LCD that can result in imbalance of charge built up among the substrates. This imbalance consequently results in a net DC and a different effective signal wave-form in two consecutive frames, which tends to cause flickering. On the other hand, flickering is also observed in an actively driven LCD where imbalance of charge is caused by the presence of a colour filter, and amorphous silicone TFT, polysilicone TFT, or the like on one of the two glass substrates 3. In the case of a reflective single crystal (CMOS) a micro-display, one of the glass substrates is replaced by silicone die, or substrate 11, causing an even higher degree of imbalance, as shown in FIG. 6. To minimize this flickering caused by imbalance of an effective signal wave-form, a row/column inversion method is used for an actively driven LCD such that the flickering effect is spatially averaged out to an extent that it is imperceptible, FIGS. 7, 8 and 9 respectively showing the signal wave-form 12, 13, 14 incorporating row, column and pixel inversion schemes or methods.

In each case there is a switching signal 50, the ITO voltage being shown at 16.

Turning now to FIGS. 10, 11 and 12, there is shown respectively the polarities 17, 18 and 19 of the resulting fields applied to pixels for two consecutive frames utilising row, column and pixel inversion methods or schemes. In the top frame N in each case it can be seen that in each matrix the polarity is reversed for the equivalent frame N+1 on inversion. For passively driven LCDs, row inversion can be utilised to minimise the perception of flickering.

FIG. 13 shows a signal wave-form 20 incorporating row inversion, inversion occurring at the boundary line between frame N and frame N+1. In these embodiments, the inversion method embodying the invention results in reduced contrast owing to a fringe field effect occurring at a pixel boundary. This loss is relatively negligible when the pixel size is not significantly small. However, in the case of a miniature display (e.g. an amorphous silicon TFT, a polysilicone TFT and reflective CMOS miniature display), the loss of contrast can be severe and cannot be overlooked.

FIG. 14 shows 2 Director configurations 21 of two pixels of 15 μm×15 μm driven in a column inversion method.

Using the invention a multi-column/row inversion driving method greatly reduces a total fringe field effect on display to maintain the contrast, whilst minimising perception of flickering. The number of inversions can be adjusted to strike a balance between contrast and perceptibility of flickering.

Thus FIG. 15 shows the wave-form 22 with an n-row inversion where n=2, and where M is the number of scan lines. If n=M, there is a conventional frame inversion while if n=1, there is a single row inversion method. By increasing n, a reduced fringing field effect is obtained with an increase perceptibility of flickering. In FIG. 15 inversion occurs at the boundary line between frame N and frame N+1.

Likewise, and referring now to FIGS. 16, 17 and 18, they show respectively the resulting polarities of field applied to pixels for multi-row, multi-column and multi-pixel inversion for an actively driven LCD, as shown at 23, 24 and 25, in each embodiment, the polarity and frame then being reversed in each pixel matrix at frame N+1.

FIGS. 19, 20 and 21 respectively show the respective driving wave-forms 26, 27 and 28 the ITO voltage being shown at 29 in each case and the switching signal at 30.

FIGS. 19-21 show inversion methods using two-row, two-column and 2×2 pixel inversion methods. For a method which is a multi-pixel inversion method, the building blocks can be of the order of m×n, where m and/or n are greater than 1 for multi-pixel inversion methods.

### EXAMPLE

In a reflective single crystal CMOS micro-display, assuming a pixel size of 10 μm, a single column inversion resulted in reduction of contrast by 30%. Reduction of contrast is maintained below 5% by adopting a four column inversion method, at the same time flickering being imperceptible.

Thus using a method embodying the invention, a method of driving an LCD by column/row/pixel inversion methods provides for the flickering effect to be spatially averaged out to an extent that it is imperceptible, and contrast reduction is maintained to an acceptable level. Stated in other words a method embodying the invention greatly reduces total fringe field effect on a display to maintain the contrast whilst minimising perception of flickering. The number of inversions can be adjusted to strike a balance between contrast and perceptibility of flickering.

I claim:

1. A method for driving an LCD, comprising the steps of:
(i) providing an LCD with a number of columns,
(ii) providing an LCD with a number of rows,
(iii) whereby to provide a number of pixels, and
(iv) driving the LCD by multiple inversion of one of a column, row and pixel, whereby to provide a reduced total fringe field effect to maintain contrast and a minimised flickering on a display.

2. A method as defined in claim 1, wherein the multiple inversions are adjustable.

3. A method as defined in claim 1, wherein there is a number of columns (m) which is any integer from two to the number of scan lines and wherein there is a number of rows (n) which is any integer from two to the number of column lines.

4. A method as defined in claim 3, wherein there is an (n)-row inversion applied to a passively and an actively driven LCD, and wherein (n) is any integer from two to the number of scan lines.

5. A method as defined in claim 3, wherein there is an (m)-column inversion applied to an actively driven LCD, (m) being any integer from two to the number of column lines.

6. A method as defined in claim 3, wherein there is an n×m-pixel inversion in an actively driven LCD, where (n) is an integer from two to the number of scan lines and (m) is an integer from two to the number of column lines.

7. A method as defined in claim 1, wherein said method is applied to one of an actively driven miniature TFT LCD and a reflective liquid crystal on silicon LCD.

8. A method as defined in claim 1, wherein there is simultaneous inversion of one of a plurality of columns, rows or pixels of an LCD.

9. A method as defined in claim 8, wherein said plurality comprises two.
